(19) United States
(12) Patent Application Publication
(10) Pub. No.: US 2009/0037637 A1
(43) Pub. Date: Feb. 5, 2009

(54) MULTIUSER-MULTITASKING COMPUTER ARCHITECTURE

(76) Inventor: Min-Chuan Wan, Hsinchu City (TW)

Correspondence Address: JOHN CHEN, ROOM 303, 3F, NO. 25, SEC. 1, CHANGAN E. ROAD, TAIPEI, 10441, TW

(21) Appl. No.: 11/831,976

(22) Filed: Aug. 1, 2007

(51) Int. Cl. G06F 15/00

(52) U.S. Cl. 710/315; 710/306

(57) ABSTRACT

The present invention provides a multiuser-multitasking computer architecture, comprising a computing system comprising a chip set; an interface station connected to said computing system through a connection wire to transport data, wherein said interface station comprises a interface circuit; a monitor connected to said interface station; and an input device connected to said interface station.

### BACKGROUND OF THE PRESENT INVENTION

1. Field of Invention

The invention relates to a computer architecture, and more particularly to a multiuser-multitasking computer architecture.

2. Description of Related Arts

A conventional multiuser-multitasking computer architecture is implemented in the Server-Client architecture that communicates data by Ethernet, referring to FIG. 1. Users use thin clients 102 to access data from the server 101 to accomplish computing tasks they need. But the cost of the Server-Client architecture is too high, especially expensive hardware cost on the thin clients.

A thin client is considered as a computer system but without storage devices, ex hard disk device (HDD). If adopting x86-based computer systems, the cost of a thin client is almost equal to a standard Personal Computer (PC) except HDD. For the purpose of decreasing hardware cost to adopt RISC-based SOC systems, ex: ARM, the relevant OS, drivers, and even applications for the Server-Client architecture have to be modified massively. The time and money for developing the software applied on the RISC-based Server-Client architecture will be increasing extraordinarily. Besides, almost entire data computing is executed in the server; therefore the CPUs of the thin clients become a waste in terms of the hardware investment, especially when the multi-core/multi-processor server which can handle extremely heavy computing loads at the same time is available and popular now.

Referring to FIG. 2, it is the other conventional multiuser-multitasking computer architecture, a Host-Client architecture. Every client terminal 203, including a monitor and input devices such as a keyboard and a mouse, is connected to the host system a computer 201, through the corresponding graphics card 202 and the corresponding USB interface 204. The graphics cards 202 are inserted into the host system 201. For accommodating more graphics cards to expand more client terminals, the volume of the host system 201 must be large. Another drawback is that the chassis or case of the host system 201 must be opened while inserting a new graphics card. It causes safety and security concerns.

Therefore, there is a demand to provide a new architecture to resolve the problems mentioned above.

### SUMMARY OF THE PRESENT INVENTION

An object of the present invention is to reduce the total cost of ownership of a multiuser-multitasking computer architecture.

Another object of the present invention is to increase the convenience to expand the network of a multiuser-multitasking computer architecture.

Accordingly, in order to accomplish the one or some or all above objects, the multiuser-multitasking computer architecture comprises: a computing system comprising a chip set, an interface station connected to said computing system through a connection wire to transport data bi-directionally, wherein said interface station comprises a interface circuit; a monitor connected to said interface station; and an input device connected to said interface station..

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 illustrates a conventional multiuser-multitasking computer architecture.

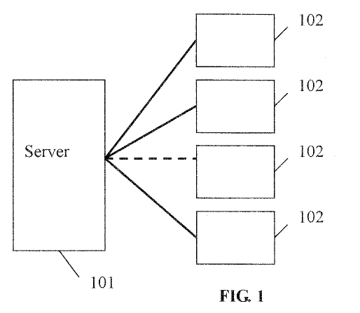

FIG. 2 illustrates the other conventional multiuser-multitasking computer architecture.

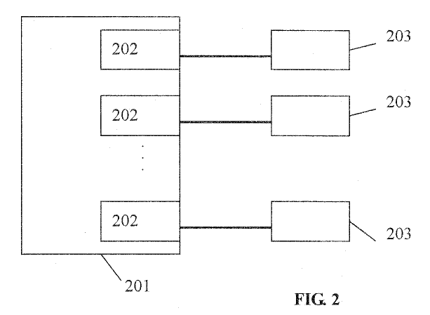

FIG. 3 illustrates the multiuser-multitasking computer architecture in accordance with the present invention.

FIG. 4 illustrates an embodiment of an interface station in accordance with the present invention.

FIG. 5 illustrates another embodiment of an interface station in accordance with the present invention.

### DETAILED DESCRIPTION OF THE PREFERRED EMBODIMENT

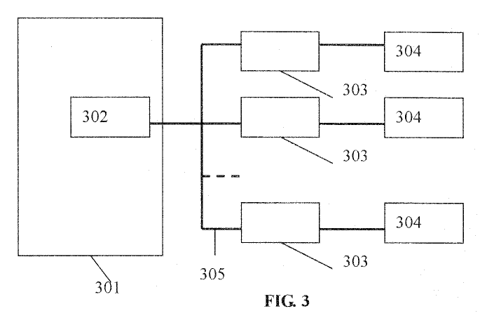

In an embodiment, referring to FIG. 3, it illustrates the multiuser-multitasking computer architecture in accordance with the present invention. A computing system 301, such as a PC or a server to be used as the host system, comprises a chipset 302 connected to the interface stations 303 through connection wires 305 for the connections with the client terminals 304. The connection wires 305 can bi-directionally transport data via PCI Express protocol or USB protocol. The connection wires 305 can be plugged in a connector of the computing system 301.

The chipset 302 may comprise a north bridge and a south bridge. The connection to the interface stations 303 may come from the north bridge or the south bridge, or from both of them, depending on the design option.

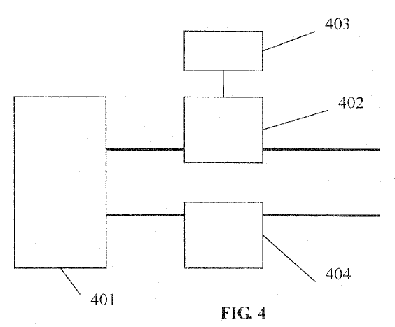

The interface station 303, as shown in FIG. 4, may comprise a interface circuit 401, supporting PCI Express and/or USB protocols, a USB Hub controlling circuit 404 connected to the interface circuit 401, a graphics processing unit (GPU) 402 connected to the interface circuit 401, and the memory 403, such as a DRAM, for the GPU 402.

The interface circuit 401 may be a USB-to-PCI bridge circuit for communication between USB and PCI protocols. The interface circuit 401 connects to a PCIE-interfaced USB Hub controlling circuit 404 and a PCI-interfaced GPU 402. The USB Hub controlling circuit 404 connects with input devices, such as a mouse and a keyboard. The GPU 402 connects with a monitor.

Or, the interface circuit 401 may be a PCIE-to-PCI bridge circuit for communication between PCI Express and PCI protocols. The interface circuit 401 connects to a PCI-interfaced USB Hub controlling circuit 404 and a PCI-interfaced GPU 402. The USB Hub controlling circuit 404 connects with input devices, such as a mouse and a keyboard. The GPU 402 connects with a monitor.

Or, the interface circuit 401 may be a PCTE switch for PCI Express protocol. The interface circuit 401 connects to a PCIE-interfaced USB Hub controlling circuit 404 and a PCIE-interfaced GPU 402 The USB Hub controlling circuit 404 connects with input devices, such as a mouse and a keyboard. The GPU 402 connects with a monitor.

Or, above-mentioned interface bridge function, GPU function and USB Hub function are integrated into an ASIC chip.

The client terminal 304 may comprise a monitor and input devices, such as a keyboard and a mouse. The monitor receives signals from the GPU 402, and the input devices communicate with the USB Hub controlling circuit 404.

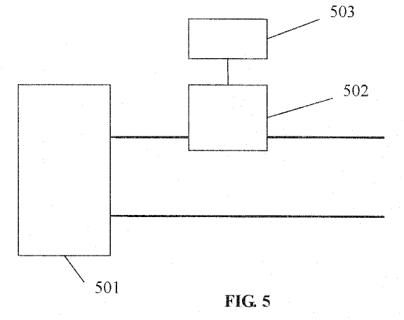

Referring to FIG. 5, another embodiment of the interface station of the present invention, the interface circuit 501 may be a USB Hub controller. The interface circuit 501 connects to a USB-interfaced GPU 502, and the GPU 502 is connected to a memory 503, such as a DRAM. The USB Hub controller 501 connects with input devices, such a mouse and a keyboard. The USB-interfaced GPU 502 is connected with a monitor. Otherwise, the GPIJ 502 can be replaced by a USB-to-VGA chip.

The client terminal 304 may comprise a monitor and input devices, such as a keyboard and a mouse. The monitor receives signals from the GPU 502, and the input devices communicate with the USB Hub controlling circuit 501.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A multiuser-multitasking computer architecture, comprising:
a computing system comprising a chipset;
an interface station connected to said computing system through a connection wire to transport data, wherein said interface station comprises a interface circuit, a GPU, a memory, and a USB Hub controller;
a monitor connected to said interface station; and
an input device connected to said interface station.

2. The multiuser-multitasking computer architecture according to the claim 1, wherein said connection wire transport said data in the PCIE protocol.

3. The multiuser-multitasking computer architecture according to the claim 1, wherein said connection wire transport said data in the USB protocol.

4. The multiuser-multitasking computer architecture according to the claim 2, wherein said interface circuit is a PCIE-to-PCI bridge.

5. The multiuser-multitasking computer architecture according to the claim 2, wherein said interface circuit is a PCIE switch.

6. The multiuser-multitasking computer architecture according to the claim 3, wherein said interface circuit is a USB-to-PCI bridge.

7. The multiuser-multitasking computer architecture according to the claim 1, wherein said input device comprises a keyboard.

8. The multiuser-multitasking computer architecture according to the claim 1, wherein said input device comprises a mouse.

9. The multiuser-.multitasking computer architecture according to the claim 1, wherein said interface circuit, said GPU and said USB Hub controller are integrated into an ASIC chip.

10. A multiuser-multitasking computer architecture, comprising:
a computing system comprising a chipset;
an interface station connected to said computing system through a connection wire to transport data, wherein said interface station comprises a interface circuit, a GPU, and a memory,
a monitor connected to said interface station, and
an input device connected to said interface station.

11. The multiuser-multitasking computer architecture according to the claim 11, wherein said interface circuit comprises a UCB Hub controller.

12. The multiuser-multitasking computer architecture according to the claim 1, wherein said GPU is a USB-to-VGA chip.

13. The multiuser-multitasking computer architecture according to the claim 11, wherein said input device comprises a keyboard.

14. The multiuser-multitasking computer architecture according to the claim 1, wherein said input device comprises a mouse.
